(19) United States
(12) Patent Application Publication
(10) Pub. No.: US 2014/0373453 A1
(43) Pub. Date: Dec. 25, 2014

(54) DEVICE FOR OPENING/CLOSING WINGS IN WING BODY VEHICLE

(71) Applicant: Soon Chase LEE, Subyeon-ro (KR)

(72) Inventor: Soon Chae Lee, Incheon (KR)

(21) Appl. No.: 14/374,478

(22) PCT Filed: Jan. 25, 2013
(86) PCT No.: PCT/KR2013/000601

§ 371 Date: Jul. 24, 2014

(30) Foreign Application Priority Data
Jan. 25, 2012 (KR) 10-2012-0007322

(51) Int. Cl. E05F 15/12; B60P 7/02

(52) U.S. Cl. CPC E05F 15/12; B60P 7/02
USPC 49/324

(57) ABSTRACT

The present invention relates to a device for opening/closing wings in a wing body vehicle, and the device for opening/closing comprises: one pair of wings, which are installed so as to rotate with respect to a frame that is formed on an outer edge of a loading box; and the wing body vehicle comprising an opening/closing device for binding together lower ends of the wings and the frame, wherein the opening/closing device comprises a forward/reverse motor which is seated on the frame; an elevating plate, which is elevated and lowered vertically by driving the forward/reverse motor, for blocking a portion of lower end portions of the wings, a close button for elevating the elevating plate, and an open button for lowering the elevating plate. According to the present invention, an actuation button is operated when the wings are lowered thereby securely fixing the wings, and a user can solidly fix or release the wings by using the open button and the close button.

### TECHNICAL FIELD

The present invention relates to a device for opening and closing wings of a wing body vehicle, and more particularly, to and more particularly, to a device for opening and closing wings of a wing body vehicle with which it is possible to firmly combine a pair of wings constituting a load box with a frame on a bottom surface by being attached to the wing body vehicle and it is possible to automatically separate or combine the wings from or with the frame by operating an open button or a close button by a user.

### BACKGROUND ART

Logistics movement using a freight vehicle is mostly in charge of transporting logistics, and a load box of the freight vehicle is mostly opened. In recent years, as products are gentrified and miniaturized and high value-added articles are provided, there are suggested lids having various configurations that can maintain a load box in an airtight state so as to prevent a problem that freight is impacted from the outside during transporting and productivity of the product is degraded, a problem that the product is stolen during transporting, a problem that the product is damaged by an external environment, and a problem that the product falls down during transporting.

A wing body is provided as a representative example, and the wing body is configured to open side doors (wings) like wings of a bird to allow the products to be load or unloaded. The wing body has excellent operation efficiency, simple manipulation and outstanding loading capability.

That is, more particularly, the wing body is a device that can transport the freight regardless of a weather condition to increase transporting efficiency and does not need a rope and lid operation to increase safety of the load or unload operation.

The wing body includes a hinge unit configured to rotate the pair of wings to open and close the load box. In general, the hinge unit includes a hydraulic system including two hydraulic cylinders respectively provided at front and rear sides of the load box, a hydraulic generator, and a control means.

### DISCLOSURE

### Technical Problem

However, the wing body can selectively open and close the pair of wings by the hinge unit, but there is a problem that a position where lower ends of the wings are coupled to the frame positioned at the lower end of the load box is manually coupled.

Accordingly, in order to solve the problems, an object of the present invention is to provide a device for opening and closing wings of a wing body vehicle with which when a wing is lowed, it is possible to bring the wing into contact with a frame on a bottom surface to automatically fix the wing to the frame, and when the wing is opened, it is possible to separate the wing from the frame by operating only one button.

### Technical Solution

In order to achieve the above object, according to one aspect of the present invention, there is provided a device for opening and closing wings of a wing body vehicle including a frame formed at an outer edge of a load box, a pair of wings which is rotatably provided, and devices for opening and closing which combine the frame with a lower end of the wing. The device includes a forward and reverse motor that settles into the frame; an elevating plate that is elevated up and down by driving of the forward and reverse motor to partially clamp the lower end of the wing; a close button that raises the elevating plate; and an open button that lowers the elevating plate.

According to another aspect of the present invention, an operation button that comes in contact with the lower end of the wing to raise the elevating plate may be further attached to the frame.

In the present invention, three devices for opening and closing may be respectively attached onto both side surfaces of the load box.

Further, three open buttons attached onto the same side surface may be connected to each other.

Furthermore, three close buttons attached onto the same side surface may be connected to each other.

### Effect of the Invention

In such a configuration of the present invention, when the wing is lowered by the hinge unit, the operation button is operated to raise the elevating plate, so that the wing is automatically fixed firmly, and when the user presses the three open buttons, the other two open buttons are operated to separate all of the wings from the frame. Further, when the user presses one close button, the other two close buttons are operated to firmly fix the wings.

### DESCRIPTION OF DRAWINGS

FIG. 1 is a perspective view of a wing body vehicle.

FIG. 2 is a side view of a wing body vehicle to which a device for opening and closing is attached for according to an embodiment of the present invention.

FIG. 3 is a partial enlarged view of major parts of FIG. 2.

FIG. 4 is a cross-sectional view of the device for opening and closing.

FIGS. 5A and 5B are cross-sectional views for describing an operation of the device for opening and closing.

FIGS. 6A and 6B are perspective views for describing the operation of the device for opening and closing.

### BEST MODE

Hereinafter, a preferred embodiment of the present invention will be described in detail with reference to the accompanying drawings, and throughout the drawings, the same reference numerals will denote the same parts.

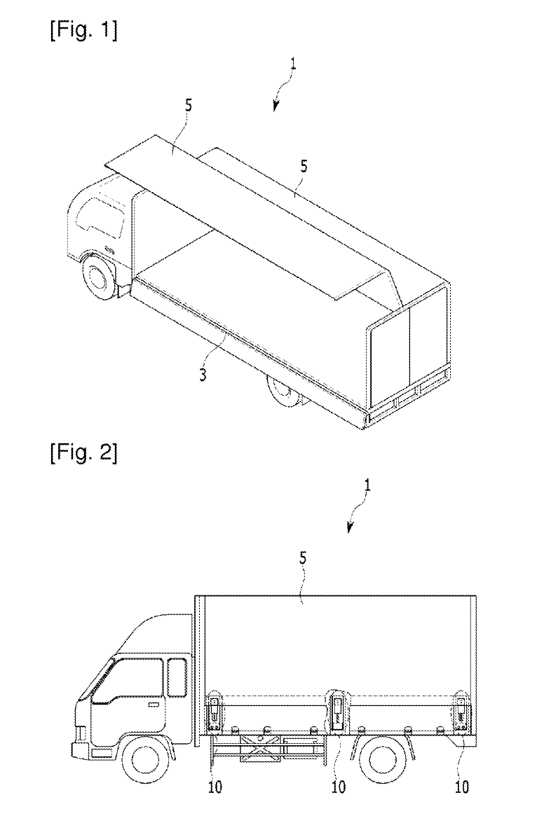

Devices for opening and closing of the present invention which are denoted by reference numeral 10 is attached to a wing body vehicle 1 shown in FIG. 1.

The wing body vehicle 1 includes a frame 3 formed at an outer edge of a load box, and a pair of wings 5 that is rotatably provided, and lower ends of the wings 5 and the frame 3 are combined by the devices for opening and closing 10.

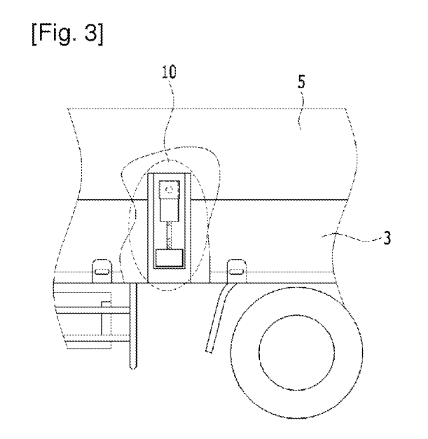

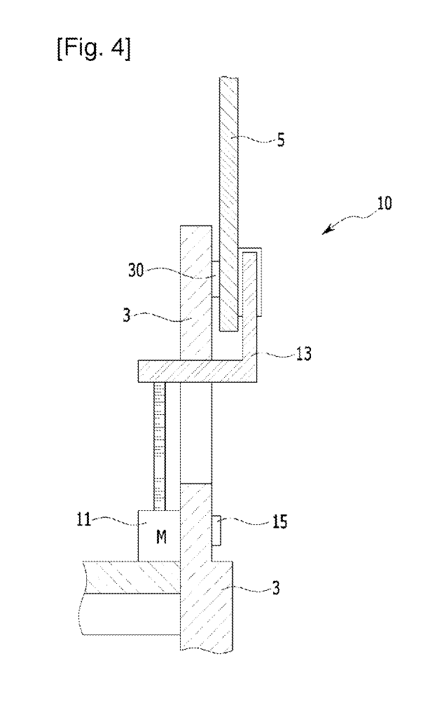

FIGS. 2 and 3 are respectively a side view of the wing body vehicle 1 to which the devices for opening and closing 10 according to the embodiment of the present invention are attached and a partial enlarged view of major parts thereof. FIG. 4 is a cross-sectional view of the device for opening and closing 10.

As shown in the drawings, the devices for opening and closing 10 of the present invention are attached to side surfaces of the wing body vehicle 1, and three devices for opening and closing are preferably attached to each of both side surfaces.

The devices for opening and closing 10 of the present invention includes a forward and reverse motor 11, an elevating plate 13, a close button 15, and an open button 17.

The forward and reverse motor 11 is attached to the frame 3, and is rotated in a forward or reverse direction depending on a current direction. The elevating plate 13 is a plate that is elevated up and down by the forward and reverse motor 11.

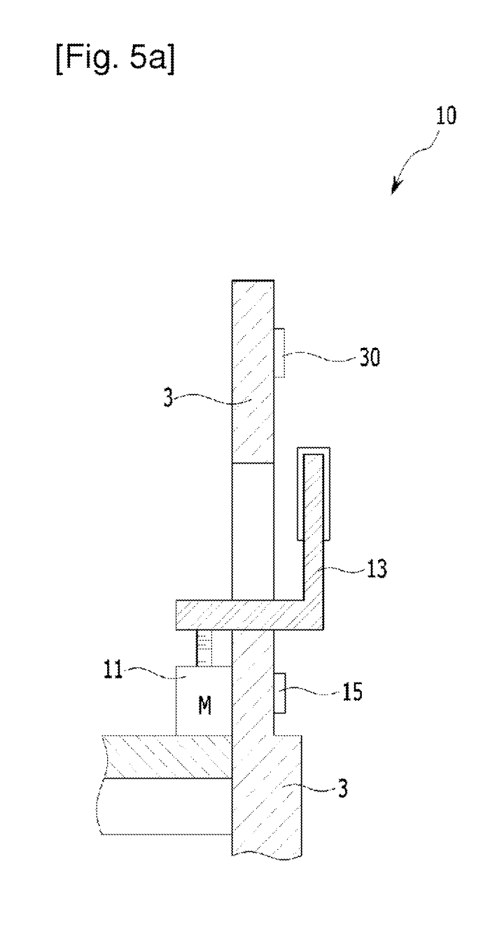

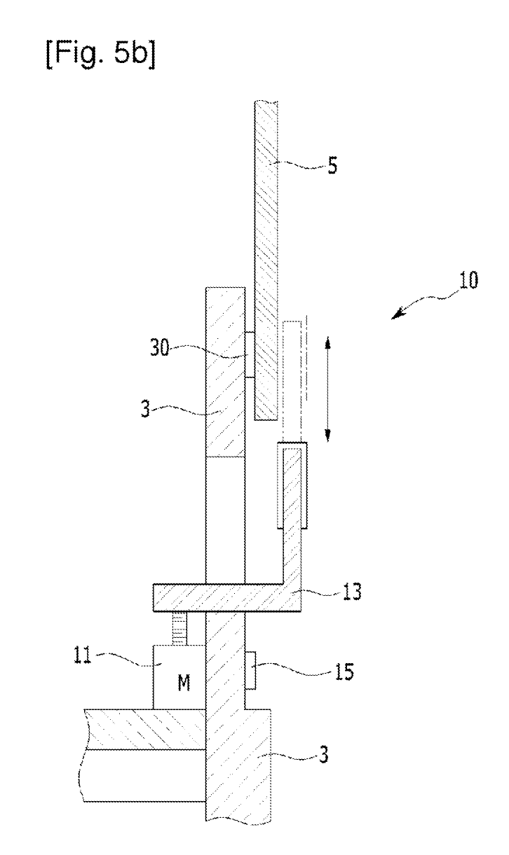

As shown in FIGS. 5A and 5B, when the elevating plate 13 is moved up, the elevating plate clamps the wing 5 to fix the wing, and when the elevating plate is moved down, the wing 5 can be opened.

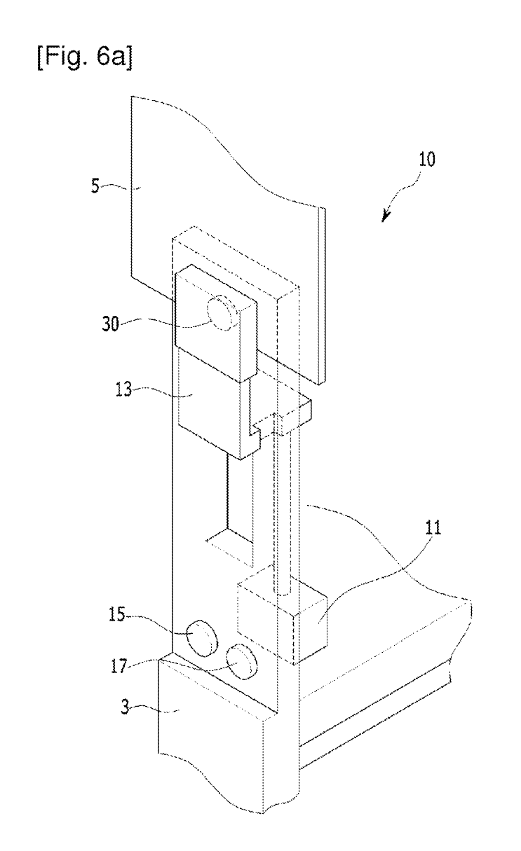

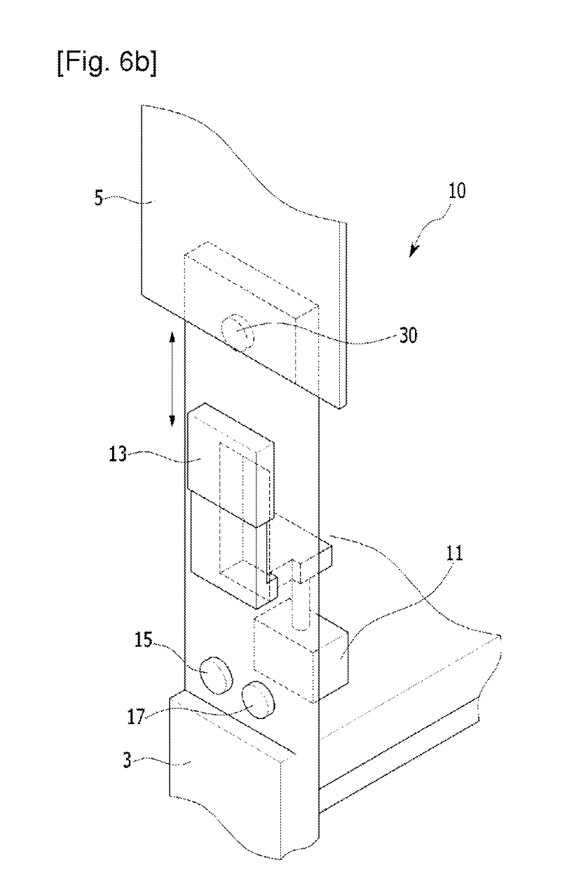

As shown in FIGS. 6A and 6B, the device for opening and closing 10 includes the close button 15 and the open button 17. Since the close button 15 is electrically connected to the forward and reverse motor 11, when a user presses the close button, the forward and reverse motor 11 is operated to move up the elevating plate 13. The open button 17 operates the forward and reverse motor 11 by a manipulation of the user to move down the elevating plate 13.

As shown in the drawings, the close button 15 and the open button 17 are attached to the frame 3 to be exposed to the outside.

As shown in FIG. 2, three devices for opening and closing 10 are respectively attached onto both side surfaces of the vehicle. Thus, since three close buttons 15 attached to the same side surface are connected to each other, when the user presses one close button 15, the other two close buttons 15 are similarly operated. Further, the three open buttons 17 attached to the same side surface are connected to each other.

Moreover, an operation button 30 that comes in contact with a lower end of the wing 5 to raise the elevating plate 13 is further attached to the frame 3. That is, as shown in FIGS. 5A and 5B, the operation button 30 is attached onto an outer surface of the frame 3 coming in contact with the wing 5. In addition, since the operation button 30 is connected to the forward and reverse motor 11, when the wing 5 is lowered to press the operation button 30 exposed at the frame 3 as shown in FIG. 5A, the elevating plate 13 is raised to clamp the lower end of the wing 5 as shown in FIG. 5B.

Further, the open button 17 is connected to a hinge member (not shown) that operates the wing 5. Accordingly, when the user operates the hinge member in order to open the closed wing 5, the open button 17 is automatically operated to lower the elevating plate 13.

The aforementioned description is presented to implement the device for opening and closing wings of the wing body vehicle according to the present invention, and the present invention is not limited to the embodiment. It is appreciated to those skilled in the art that various modifications are possible and would fall within the technical spirit of the present invention without departing the gist of the present invention as claimed in the appended claims.

### INDUSTRIAL APPLICABILITY

The present invention relates to a device for opening and closing wings of a wing body vehicle, and more particularly, to a device for opening and closing wings of a wing body vehicle with which it is possible to firmly combine a pair of wings constituting a load box with a frame on a bottom surface by being attached to the wing body vehicle and it is possible to automatically separate or combine the wings from or with the frame by operating an open button or a close button by a user. Accordingly, the device opening and closing can be industrially used.

1. A device for opening and closing wings (10) of a wing body vehicle including a frame (3) formed at an outer edge of a load box, a pair of wings (5) which is rotatably provided, and devices for opening and closing (10) which combine the frame (3) with a lower end of the wing (5), comprising:
a forward and reverse motor (11) that settles into the frame (3);
an elevating plate (13) that is elevated up and down by driving of the forward and reverse motor (11) to partially clamp the lower end of the wing (5);
a close button (15) that raises the elevating plate (13); and
an open button (17) that lowers the elevating plate (13).

2. The device for opening and closing wings of a wing body vehicle of claim 1, wherein an operation button (30) that comes in contact with the lower end of the wing (5) to raise the elevating plate (13) is further attached to the frame (3).

3. The device for opening and closing wings of a wing body vehicle of claim 1, wherein three devices for opening and closing (10) are respectively attached onto both side surfaces of the load box.

4. The device for opening and closing wings of a wing body vehicle of claim 3, wherein three open buttons attached onto the same side surface are connected to each other.

5. The device for opening and closing wings of a wing body vehicle of claim 3, wherein three close buttons (15) attached onto the same side surface are connected to each other.

6. The device for opening and closing wings of a wing body vehicle of claim 2, wherein three devices for opening and closing (10) are respectively attached onto both side surfaces of the load box.
